(19) United States
(12) Patent Application Publication
(10) Pub. No.: US 2021/0141996 A1
(43) Pub. Date: May 13, 2021

(54) SYSTEM AND METHOD FOR NOTE TAKING AND MANAGEMENT

(71) Applicant: Chad K. Agrawal, Woodcliff Lake, NJ (US)

(72) Inventor: Chad K. Agrawal, Woodcliff Lake, NJ (US)

(21) Appl. No.: 17/156,350

(22) Filed: Jan. 22, 2021

Related U.S. Application Data
(63) Continuation-in-part of application No. 16/002,428, filed on Jun. 7, 2018, now Pat. No. 10,929,454.

(51) Int. Cl. G06F 40/166; G06F 40/117; G06F 40/137; G06F 16/838

(52) U.S. Cl. CPC G06F 40/166; G06F 16/838; G06F 40/137; G06F 40/117

(57) ABSTRACT

A system and method for automatically logging a note, is disclosed. The method incorporated in the system comprising: receiving at least one user input via a display module of the electronic device, importing one or more electronic notes stored in the memory unit of the electronic device; determining, at the processing unit, via a delimiter, identifying one or more headers and one or more single empty lines in one or more electronic notes; obtaining a content via one or more empty lines and one or more header, adding the content to a log note matching or corresponding to one or more headers and removing a logged content from one or more electronic notes, and exporting remaining one or more electronic notes and displaying at least one auto log note from the electronic notes.

### CROSS-REFERENCE TO RELATED APPLICATIONS

This application is a continuation-in-part of a U.S. non-provisional patent application serial number filed Ser. No. 16/002,428, filed on Jun. 7, 2018 which is incorporated herein by reference in its entirety.

### TECHNICAL FIELD

The present invention generally relates to a system and method for note taking and management, and more particularly, the present invention relates to a system and method for note taking and automated organization/management of notes.

### DESCRIPTION OF RELATED ART

Generally, in a world where notes are used for tasks, to-do lists, thoughts, journals, diaries, content, and the like, individuals have to transfer content between notes to log them in an organized fashion. Also, notes have been broadly used for various purposes in sharing ideas and information. For example, during discussions or brainstorming sessions the participants write down minutes, tasks, ideas, thoughts, and like on a writing pad, I-pad, laptop, and mobile devices. Also, people commonly use notes throughout the day to memorialize information or content which the individual does not want to forget such that they can save it as a checklist. As additional examples, people frequently use notes as reminders of actions or events to take in the future, such as to make a mobile call, revise a document, or to fill out a timesheet, etc.

Electronic devices have input interfaces for users for note-taking using one or more functionalities of the electronic devices. For example, a mobile phone can have a keypad or touch-sensitive display for users to input data. Users can input different categories of information in separate applications, such as work tasks, ideas, journal contents, etc. For example, users can activate a notepad application on an electronic device and takes notes by entering the information. The notes can be taken at different times and for several purposes. It can be difficult and time-consuming for a user to enter several notes over a day. The result can be a clutter of information stored in the different applications, and users need to log in separately to each application for access. The user may try a time-consuming process of organizing the notes but may fail or end up with a bigger jumble.

Using the note-taking application in the mobile device, a laptop, or any other electronic device, users can take and organize the notes at will. Currently, the notes are generated as files and stored in the corresponding application. Generally, it is hard for users to manage the notes when a large number of notes are simultaneously created and stored in a different place. For example, when a review of a specific note is needed, it may be hard to locate the specific note in the application. Past systems are limited to generating, editing, and labeling notes. The only way to organize the notes is by arranging and rearranging the content manually. Older systems require redundant iterations of the steps by users, resulting in wastage of precious time and efforts.

In the light of above-mentioned problems, there is a need for a system that permits users to take notes and organize/manage the notes easily and efficiently.

### SUMMARY OF THE INVENTION

The present invention discloses a note-taking and management system, for instance, the system and method for automated management or organization of the notes. A method and system for automatically logging a note are disclosed. The automated notes management system comprises an electronic device having a memory unit and a processing unit for generating one or more electronic notes. Receiving at least one user input via a display module of the electronic device, importing one or more electronic notes stored in the memory unit of the electronic device. Determining at the processing unit, via a delimiter, identify one or more headers and one or more single empty lines in one or more electronic notes. Obtaining content via one or more empty lines and one or more headers. Adding the content to a log note matching one or more headers and removing a logged content from one or more electronic notes. Exporting a remaining one or more electronic notes and displaying at least one auto log note from the electronic notes.

In one embodiment the auto-note management system comprises an electronic device, a network, and a server. The electronic device could be any computing device that is capable of receiving input from a user and displaying information about notes. In the illustrated embodiment, the electronic device includes a memory unit, a processing unit, and a task list generator to generate one or more electronic note.

In one embodiment the method/process of auto-management is an embodiment of the present invention. Providing an electronic device comprising a memory unit and a processing unit connected to the memory unit. Generating one or more electronic notes in a plurality of configurations for associating with one or more contexts and application items. At another step, receiving at least one user input via a display module of the electronic device. At another step, importing one or more electronic notes of the one or more context and application items stored in the memory unit of the electronic device. At another step, determining at the processing unit, via a delimiter, identify one or more headers and one or more single empty lines in one or more electronic notes. At another step, obtain the content between one or more empty lines. At another step, if one or more single empty lines are not identified, logging is not required. At another step, if one or more single empty lines are identified obtaining content via one or more empty lines and one or more headers. At another step, adding the content to a log note matching one or more headers and removing a logged content from one or more electronic notes. At another step, exporting a remaining one or more electronic notes from the plurality of configurations for associating with different contexts and application items. Displaying at the processing unit, via a display module, at least one auto-log note from the electronic notes.

The electronic device of the auto note management system could include any devices such as a PDA (personal digital assistant), a smartphone, a mobile phone, a MID (Mobile Internet Device), a tablet, a desktop computer, a laptop computer, a car computer, a digital camera, a multi-media player, a game device, or any other type of computational device, not limited thereto. The processing unit may include any machine, electronic, magnetic, optical, electrochemical, or other high-speed data processing device performing a logical, arithmetic, or storage function, and may include, but not be limited to, both a computer central processing unit. The electronic note is configured to generate notes items based on user inputs.

In one aspect, disclosed is a method of note-taking and automated organization/management of the notes. The disclosed method includes the steps of providing an interface on an electronic device for taking notes, project tags, additional information, and delimiters from a user, the electronic device can include a memory unit and a processing unit that is connected to the memory unit. The electronic device, through the interface, can receive a first note and a second note, wherein the first note and the second note are consecutive, the second note after the first note. Associating the first note and the second note to a header. A sub-list can also be created that can be associated with the header. A delimiter can be received through the interface before the second note. Upon receiving the delimiter, the delimiter can be recognized and in response, selectively moving the second note to the sub-list at a predetermined time based on the delimiter. The second note can then be associated with a predetermined function. A third note can be received and associated with the header, wherein the third note can be arranged consecutively after the first note. The consecutive first and the third note can then be presented to the user through an interface on the user device.

In one aspect, the method for taking notes and automated management of the notes further includes a step of date and time stamping of the notes including the above the first note, the second note, and the third note.

In one aspect, the delimiter can be selected from a group consisting of a line break, a symbol, a slash, a backslash, a colon, a semi-colon, or a period.

In one aspect, disclosed is a non-transitory computer-readable storage medium that can include instructions that, when executed by at least one processing device, cause the at least one processing device to perform one or more steps including providing an interface for receiving notes and delimiters from a user; receiving a first note and a second note, wherein the first note and the second note are consecutive, the second note after the first note; associating the first note and the second note to a header; create a sub-list associated with the header; receiving a pair of consecutive delimiters before the second note; identifying the pair of consecutive delimiters; and upon identification of the pair of consecutive delimiters, selectively move at a predetermined time, the second note based on the delimiter, to the sub-list; receiving, through the interface, a third note associated with the header, the third note consecutively arranged after the first note; and presenting, at an interface, the first note and the third note on the user device.

In one aspect, the one or more steps executed by the processor can include adding the date and time stamp to the notes including the first note, the second note, and the third note.

In one aspect, disclosed is a method of taking notes and automated organizing of the notes. The method includes the steps of creating a list of headers ordered in a series and includes a first header, a second header after the first header, a third header after the second header, and so on. The list of headers can be presented on an interface. One or more notes can be taken through the interface under any of the headers. In one case, two consecutive notes a first note and a second note are taken under the first header. A delimiter can be received between the notes, for example, a line break is inserted after the first note and before the second note. The method includes a step of recognizing the delimiter and moves the notes between the delimiter and the next header in the ordered header list to a sub-list, wherein the sub-list is associate with the header having the delimiter and the moved notes. In the above example, the second note which is between the delimiter and the second header is moved to a sub-list which is associated with the first header.

In one aspect, disclosed is a method of taking notes and automated organizing of the notes. The method includes the steps of creating a list of headers ordered in a series and includes a first header, a second header after the first header, a third header after the second header, and so on. The list of headers can be presented on an interface. One or more notes can be taken through the interface under any of the headers. In one case, two consecutive notes a first note and a second note are taken under the first header. A pair of consecutive delimiters can be received before the notes that has to be moved, for example, two line breaks is inserted after the first note and before the second note. The method includes a step of recognizing the pair of consecutive delimiters and moves the notes between the pair of consecutive delimiters and the next header in the ordered header list to a sub-list, wherein the sub-list is associate with the header having the pair of consecutive delimiters and the moved notes. In the above example, the second note which is between the pair of line breaks and the second header is moved to a sub-list which is associated with the first header.

In one aspect, the notes taken can include a project tag, also referred to hereinafter as the project key, which can be a combination of alphanumeric characters. The tag can be appended anywhere in the note, but preferably at the beginning or end of a note. For example, the first four letters of the note can be a tag, wherein the four letters can be capital letters to recognize the Tag. Alternatively, the tag can be such as a combination of alphanumeric characters that is not a used word in written language, such as not a dictionary term. Still, alternatively, the tag can have a symbol at the end, such as a hyphen separating the tag from the rest of the note. The list of such tags can be predefined in the system. Additionally, one or more notes may contain marked-up information, such as, but not limited to, completed time variable indicating the duration of a task or activity related to the note, billable time variable, and duration time variable. Mark-ups may be predefined in the system or defined by a user. Rules for parsing up the mark-ups can also be defined, such as a variable can be linked to a mark-up tag.

In one aspect, reports can be generated from the main list (interface) and sub-lists having notes which are both the date and time stamped. The sub-list provides sorting and grouping of the notes based on the date. The notes associated with a sub-list can be organized into groups based on dates, wherein the group having a sub-header which can be date or range of dates. Template for report and rules for extraction of data can be predefined or defined by a user. Based on this, the system can parse each line of one or more groups in a sub-list, wherein each line represents a note. If a query tag is present in a line, control can continue parsing the line to recognize any mark-up tags. Upon recognizing the mark-up tags, can extract the associated marked-up information. The marked-up information can be appended to associated variables. Additionally, each group in a sub-list can have a sub-header. In case, the groups are based on Date, the sub-head can be a date. The sub-header associated with a note being reported can also be included in the report.

Other objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram that illustrates an exemplary system for an auto-note management, according to an embodiment of the present invention.

FIG. 2 is a screenshot of one or more electronic notes in an embodiment of the present invention.

FIG. 3 is a flowchart illustrating the method/process of auto-note management system in an embodiment of the present invention.

FIG. 4 is a screenshot of timeline for the auto-note management in an embodiment of the present invention.

FIG. 5 is a screenshot of automatically adding dates to an auto log note in an embodiment of the present invention.

FIG. 6 is a screenshot of adding delimiter for the auto-note management in an embodiment of the present invention.

FIG. 7 is a screenshot of viewing the auto log note in an embodiment of the present invention.

FIG. 8 illustrates a process between a processing unit and a user interface of the electronic device in an embodiment of the present invention.

FIG. 9 illustrates an exemplary device incorporated in the system of FIG. 1 according to an embodiment of the present invention.

FIG. 10 is a screenshot of the auto log note in an embodiment of the present invention.

FIG. 11 illustrates an upgrading mechanism of the auto log note in an embodiment of the present invention.

FIG. 12 shows a sub-list in which notes are organized in groups based on date and a report generated from the sub-list.

FIG. 13 shows an exemplary embodiment of the project tags and mark-up tags in a sub-list, and a list of predefined project tags or keys.

FIG. 14 is a flow chart showing an exemplary embodiment of the report generation layer of the system.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention discloses a system and method for automatically logging a note. The auto-note management system 100 comprises an electronic device 110, a network 116, and a server 118. The electronic device 110 could be any computing device that is capable of receiving input from a user and displaying information about notes. In the illustrated embodiment, the electronic device 110 includes a memory unit 102, a processing unit 104, and a task list generator 106 to generate one or more electronic notes. The electronic device 110 could include any devices such as a PDA (personal digital assistant), a smartphone, a mobile phone, a MID (Mobile Internet Device), a tablet, a desktop computer, a laptop computer, a car computer, a digital camera, a multi-media player, a game device or any other type of computational device, not limited thereto. The processing unit 104 may include any machine, electronic, magnetic, optical, electrochemical, or other high-speed data processing device performing a logical, arithmetic, or storage function, and may include, but not be limited to, both a computer central processing unit. The electronic note is configured to generate notes items based on user inputs. The auto-note management system 100 combines and automates the notes from the task list generator. The electronic device 110 could include a plurality of configurations for associating with one or more contexts and application items. The server 118 is illustrative of a general-purpose or other computing device operating as a remote server on which the functionality of the auto-note management system 100 as described herein. Server 118 comprises a delimiter module 112 and a task generation module 114. In some embodiments, all functionality and data storage associated with the auto-note management system 100 having sufficient computer-executable instructions for performing the functions described herein. The functionality and associated data for the auto-note management system 100 could be maintained and operated at server 118. In one embodiment, server 118 could host multiple modules for auto-note management system 100.

The electronic device 110 includes a variety of physical input units (such as a keyboard, a mouse, a touchpad, or a touch screen). Any of these user interface units may be implemented as an external unit that communicates with the electronic device 110 to provide user input using a wired or wireless communication technology. Through these user interface units, the electronic device 110 could receive physical or voice inputs from the user.

FIG. 2 is a screenshot of one or more electronic notes in an embodiment of the present invention. In one embodiment, the processing unit 104 uses headers to determine whether any auto log notes 120 are associated with a particular information or data type. The one or more electronic notes are logged with date automatically with headers for each note separately. A user can create a process executed by the electronic device 110 or server 118 to complete required tasks and provide the user with notes logging automation.

In one embodiment, the user inputs a note into the electronic device 110. Under any headers in the task list generator 106 electronic note, the user adds one or more empty lines above any content to be logged. One or more empty lines can be inputted in any way, including but not limited to, pressing enter on a keyboard (once on a double-spaced note or twice on a single-spaced note). Either on command or at a scheduled time, the processing unit 104 automatically logs the appropriate content to other notes (as described above).

FIG. 3 is a flowchart illustrating the method/process 300 of auto-note management, incorporated in system 100 (as shown in FIG. 1 and FIG. 2), in an embodiment of the present invention. The method 300 includes, providing an electronic device 110 comprising a memory unit 102 and a processing unit 104 connected to the memory unit 102. Further, the method 300 further generates one or more electronic notes in a plurality of configurations for associating with one or more contexts and application items. At step 302, the method 300 further receives at least one user input via a display module of the electronic device. At step 304, the method 300 further imports one or more electronic notes of the context and application items stored in the memory unit 102 of the electronic device 110.

At step 306, the method 300 further determines or identifies at the processing unit, via a delimiter 108, one or more headers and one or more single empty lines in one or more electronic notes. At step 308, the method 300 further obtains the content between one or more empty lines. At step 310, if one or more single empty lines are not identified, logging is not required. At step 312, if one or more single empty lines are identified, the method 300 further includes, obtaining a content via one or more empty lines and one or more headers. At step 314, the method 300 further includes, adding the content to a log note matching one or more headers and removing a logged content from one or more electronic notes. At step 316, the method 300 further includes, exporting remaining one or more electronic notes from the plurality of configurations for associating with different contexts and application items. The method 300 further displays at the processing unit, via a display module, at least one auto-log note 120 from the electronic notes.

FIG. 4 is a screenshot of timeline for the auto-note management 100 in an embodiment of the present invention. Each auto log notes 120 of the one or more electronic notes are separated by the header during auto-logging. An empty line is inserted between the electronic notes. The electronic notes above the empty lines remains in an auto log note. The electronic notes below the empty lines are logged out from the auto log note. The auto-note management system 100 logs into the electronic note and add dates to log notes automatically. After logging, the user interface displays a timeline auto-note 124 with separate headers.

FIG. 5 is a screenshot of automatically adding dates to an auto log note in an embodiment of the present invention. The timeline auto-note 124 with separate headers are identified by the auto-note management system 100. Automatically dates are added for each one of the sub-list 122 generated by the task list generator 106.

FIG. 6 is a screenshot of adding delimiter for the auto-note management in an embodiment of the present invention. In one embodiment the electronic device 110 also include a delimiter 108. The delimiting characters includes one or more characters, but not limited to, an empty or blank line (‘ ’), a new line or end of line (CR LF, CR, LF, \n, \r\n), a symbol/character such as a space (‘ ’), an asterisk (‘*’), a pound sign (‘#’), a greater-than sign (‘>’), a less-than sign (‘<’), an equal sign (‘=’), a parenthesis (‘(‘or’)’), a dash (‘-’), a slash (‘/’), a backslash (‘\’), a colon (‘:’), a semi-colon (‘;’), a period (‘.’), or the like. The task list generator 106 electronic note is selected from a group comprising of a work task, a home activity, a journal entity, a new idea and a research lesson.

FIG. 6 shows an interface displaying the main page (main interface) of the auto log notes 120 and other interfaces showing the sub-lists. The arrows show the delimiters and movement of notes from the main interface to sub-lists. The main interface is having five headers arranged in order from top to bottom. Notes can be taken below any of the headers at the main interface. For example, the dashed lines on the main interface under the headers indicate a note, and each of the five headers is shown to have two notes. The two notes under each header shown are separated by a line break. While performing the automated logging of the notes from the main interface to the sub-lists, the system can recognize the predefined delimiters on the main interface. For example, on recognizing the line break in the above example, the system moves the notes between the line break and the next header to a sub-list associated with the header that contained the notes.

FIG. 7 is a screenshot of viewing the auto log note in an embodiment of the present invention. When a user logs on to one or more electronic note, auto log notes 120 process the one or more electronic note into two types a) an updated log note and b) a logged note. The auto-note may combine and automate the one or more electronic note 126 as the updated log note. The logged notes are automated with date or timestamp for review of the user. The auto log notes 120 merges the one or more electronic note 126 into a date added sub-list 122.

FIG. 8 illustrates a process between a processing unit and a user interface of the electronic device in an embodiment of the present invention. The processing unit 104 could be implemented using hardware or a combination of hardware and software/firmware instructions. The processing unit 104 navigates, transfer and log note and performs various actions on the sub-list 122. The user is notified with priority task, activities and entries based on the date or timestamp, and user may view the pending and completed notes in a display module 128 of the electronic device 110. At the same time, user could view in the display module 128 past notes by date, already logged task, activities and entries.

FIG. 9 illustrates an exemplary device incorporated in the system of FIG. 1, according to an embodiment of this disclosure. The device 900 represents either the electronic device 110 or the server 118 in FIG. 1. In an embodiment, the device 900 includes a bus system 902. The bus system 402 supports communication between a processor 904, a memory 906, a persistent storage 908, a communications unit 910, an input/output (I/O) unit 912, and a display or display interface 914. Any suitable bus or buses could be used here.

The processor 904 processes software instructions loaded into the memory 906. The processor 904 may include a single processor, multiple processors, one or more multi-processor cores, or other type of processor depending on the particular implementation. As an example, the processor 904 may be implemented using a number of heterogeneous processor systems in which a main processor is present with secondary processors on a single chip. As another example, the processor 904 may be a symmetric multi-processor system containing multiple processors of the same type. Any suitable processing device(s) could be used.

The memory 906 and the persistent storage 908 are examples of storage devices 916. A storage device is any piece of hardware capable of storing information, such as data, program code, and/or other suitable information on a temporary or permanent basis. The memory 906 may be a random-access memory or other volatile or non-volatile storage device(s). The persistent storage 908 may contain one or more components or devices, such as a hard drive, flash memory, optical disc, or other persistent storage device(s). A storage device may be fixed or removable, such as when a removable hard drive or USB thumb drive is used.

The communications unit 910 provides for communications with other systems or devices. For example, the communications unit 910 could include a network interface card or a wireless transceiver. The communications unit 910 may provide communications through physical or wireless communications links.

The I/O unit 912 allows for input and output of data using other components connected to or integrated within the device 900. For example, the I/O unit 912 may provide a connection for user input through a keyboard, mouse, or other input device. If the device 500 includes a display 914, the display 914 provides a mechanism to visually present information to a user. The display 914 could represent a touchscreen.

In one embodiment, program code for an operating system, applications, or other programs may be located in the storage devices 916, which are in communication with the processing device 904 through the bus system 902. Instructions forming the programs may be loaded into the memory unit 906 for processing by the processing unit 904.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

FIG. 10 is a screenshot of the auto log note in an embodiment of the present invention. In one embodiment that auto-note management system 100 may be implemented on the electronic device 110 or in the server 118 based on input received at the electronic device 110. Although not depicted in FIG. 1, the one or more electronic note 130 may be stored on the electronic device 110 or in the server 118 or may be synchronized to both. If one or more electronic note 130 are stored in the server 118, the auto-note management system 100 may retrieve the auto log note 120 in response to, for example, input from a user. The processing unit automatically logs and displays the timeline auto-note 124 to the user. Empty lines and headers are used as delimiters 108 to log one or more electronic note 130. The processing unit transfers one or more electronic notes to the processing unit 104 for further processing.

In one embodiment, the user may select or create a new electronic note 130. For example, the user may enter least one work task, the journal entity, the research lesson, the new idea and the home activity of the sub-list 122. As the user types, the delimiter 108 identify single empty lines from the electronic notes dynamically. For example, as the user types the tasks into the interface of the electronic device 110 and the auto management system process and displays final auto log note 132 to the user interface.

In one embodiment, user updates in real time are modified and logged in the auto log note 120 associated with the electronic notes. The processing unit 104 checks if there are one or more single empty or blank lines. If one or more consecutive empty lines are identified by the delimiter 108, the processing unit 104 decides whether or not to log the note. If the user has included one or more consecutive empty (or blank) lines, then content will be logged to a matching or corresponding note.

FIG. 11 illustrates an upgrading mechanism of the auto log note in an embodiment of the present invention. In some embodiments, the auto log notes 120 could be synchronized with calendar application or any related applications. The auto log notes 120 could be modified/customized to include the gamification features, custom workflows, auto reminders, scheduled notes, migrated notes, social sharing, social following, social feeds and recurring notes. The auto log notes 120 could have more or less logging notes. The auto log notes 120 have scheduled notes that are transferred and notified to the user and user could modify the title or header of the auto log notes 120. The user could access an updated note with all the desired content automatically logged to other notes. The auto log notes 120 enable the user with a better note taking experience. Also, the user can access the transferred content in other notes where it has been automatically logged, saving the user time and effort require for manual logging.

Referring to FIG. 12 which shows an exemplary embodiment of a report 160 generated from a sub-list 122. The disclosed system can also provide for generating pre-defined or customized reports from the notes. This function can be particularly useful for professionals and businesses. Meaningful insights can be obtained from a cluster of data that saves time and increases the efficiency of work. Such reports can be used for activity reporting, tracking progress, presentations, and like purposes wherein summary or insights are obtained from raw data. Additionally, while creating notes, users often need to track time spent on tasks and generate reports for specific projects. Companies, teams, managers, and employees need a more efficient way of combining notes, time tracking, and reporting. The disclosed system can automatically generate project reports based on the taken notes, using the project tags/keys and marked-up information.

The taken notes may or may not contain project tags and marked-up information. Both the project tags and the marked-up information can be entered with a note or afterward by appending to the note. Moreover, the project tags and the marked-up information can be added manually or through built-in functions. The project tags and marked-up information can be manually added while entering a note at the main interface. Alternatively, a note can be later editing to append the additional information, either in the main interface or in the sub-lists. The additional information, including the project tags and marked-up information, can also be entered using functions. The notes either in the main interface or in the sub-list can be associated with functions that can receive, calculate, or measure values and associate the values with the note as marked-up information using the mark-up tags. The marked-up information may or may not be visible to a user. Alternatively, selective marked-up information may be visible to a user. An option can be there that allows a user to configure if how much marked-up information is visible.

Referring to FIG. 13 which shows an exemplary embodiment of the project tags/keys 140, mark-up tags in the sub-list 122, and variables 148-152. FIG. 13 shows a sub-list 122 associated with a header “Work Task”. As explained before, the notes taken are at least date stamped. In a sub-list, the notes can be ordered according to date. In a sub-list, notes can be also be virtually grouped based on dates. Each group may contain notes of a particular date or date range. The sub-list can have a sub-header for each group, which can be the date. For example, FIG. 13 shows the sub-list 122 having two groups of consecutive dates. Also, shown in FIG. 13 is a project tag list 140, also referred herein as the project keys list. The project tags can be marked-up or simply a combination of alphanumeric characters. Such a list of project tags can be pre-defined in the system, defined by a user, or customized by the user. For example, pre-defined lists of project tags can be available for different professions, and the users can choose a list and modify it according to their requirements. Alternatively, a user can generate their list, for example, comma-separated entries can be input by the user. The sub-list 122 shows notes beginning with the project tag followed by the note information. The tags can be added anywhere in a note, but preferably at the beginning. The tags shown in FIG. 13 are speared from the note's information by a hyphen. The project tag can be added manually by a user. Alternately, notes can be associated with a function, such as a user can tap on the note, and a project tags list window pops up, and a user can select the desired project tag from the list which is appended to the note. The system uses project tags 140 to preparing the reports. Project tag 140 can be made from a project name, acronym, ID, or tag on each line.

The processing unit parses each line in sub-list 122 to identify a project tag that is included in the project tags list. The processing unit or control can check for each project tag in the project tag's list from top to bottom. Alternatively, the processing unit can check for selective project tags, for example, the project tags selected by a user for which the report is to be provided. If a project is identified, the processing unit can receive the sub-header containing the note and store the same in an activity date variable 148. The processing unit can further parse the note for extracting marked-up information, if available. Additional information related to a note can be stored using mark-up tags. Different variables can be created to receive the marked-up information. For example, FIG. 13 shows variables 148-152 for storing project tags and marked-up information. Rules can be made for defining the mark-up tags, variables, and queries. Such rules can be pre-defined, defined by a user, or customized. Mark-up tags can be closed brackets, summation signs, and like. The system can check that a delimiter for automated logging of the notes is not defined as a mark-up tag. The processing unit stores the value between brackets “(” and “)” as a duration time variable 150. In case, no value is available in a note for a variable, the value “0” can be stored. In the same line, the processor parses the line for the mark-up tag “+” and stores the value directly after the “+” as a billable time variable 151. In the same line, the processor parses the line for 3-4 consecutive numeric digits at the end of the line and stores the value at the end of the line as a completed time variable 152. Such marked-up additional information may be visible, partially visible, or hidden from a user. But an option can be provided for a user to select if what is shown. The marked-up information can be added while taking a note or later appended to the note. Alternatively, the marked-up information can be added using pre-defined functions. For example, a timer function can be associated with the notes, which can calculate the time for completion of a task and append the value of same as marked-up value to the note.

Reports can be prepared using pre-defined templates that can be customized by a user. Alternatively, a user can create their report templates. Users can input the selection of project tags and variables, wherein the selected project tags also act as query tags, and the variables are associated with mark-up tags. Moreover, formatting can be defined, for example, FIG. 12 shows a report for project tag “SBUX” in which entries are separated by tab spaces. In report 160, the activity date variable 148 is appended to the corresponding project time report 160. To the same line, the activity content variable 149, duration time variable 150, billable time variable 151, and completed time variable 152 are appended. The variables can be separated by a tab, space, comma, or like. The processing unit or the control of the processing unit can parse each line one-by-one in a group or multiple groups in a sub-list. For example, while preparing the report, the user can request report for one or more project tags and for a particular date range. Groups within the provided date range can be parsed by the processor. Additionally, the processing unit can parse the notes in different sub-list and also in the main interface.

In one exemplary embodiment, the processor can check for each project tag in the project tags list 140. First entry in the project tag list can be checked by parsing the notes. If no note can be found having the queries project tag, the second entry in the project tag list can be checked by the processor. The steps can be repeated till the last entry in the project list is checked. Now, the user have data extracted from the notes for all the project tags in the pre-defined project tag's list. A comprehensive report can be generated for all the tags, wherein filters and graphical analysis tools can also be provided for analysis. For example, the user, in the report interface, a select the deaired project tags using a drop-down menu. Similarly, in the report format, the user can have options to select desired variables. The reports can be exported in desired format, such as PDF. The reports can also be printed or shared through electronic means.

Referring to FIG. 14, which shows an exemplary embodiment of the report generation. At step 1, a user inputs the report generation request, which may include query project tags, dates, and variables. A user may specify the report template, any rules, and the variables in the report. Alternatively, a general query can be run which checks all the predefined project tags and marked-up values. The processor can then import the project key list, at step 2 and logged notes stored in the electronic device, at step 3. Each project tag in the list can be checked for in the notes at steps 4-8. Each note can be referred herein to a line in the memory, wherein the line having a matched project tag can be parsed. The sub-header having the date that is associated with a line having the query project tag can be identified at step 9 and the value of the sub-header i.e. the date can be stored in a variable, at step 10. The line having the project tag can be further parsed for additional information (marked-up information), at step 11, 16, and 19, wherein the marked-up values can be stored in associated variables, in steps 14, 15, 18, and 21. In case, a marked-up value is not available, blank “0” can be filled in the associated variable, at steps 12, 13, 17, and 20. The report based on the pre-defined template can then be presented on the report interface, at step 22. The user can customize the report, by changing the template, changing the selection of the project tags and variables, and formatting the report.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A method for note taking and automated management of notes, the method comprising the steps of:
providing, an interface, on an electronic device, configured for receiving notes and delimiters from a user, the electronic device comprising a memory unit and a processing unit connected to the memory unit;
receiving, by the electronic device, through the interface, a first note and a second note, the first note and the second note are consecutive, the second note after the first note;
associating, by the electronic device, the first note and the second note to a header;
creating, by the electronic device, a sub-list associated with the header, the sub-list having a plurality of notes, one or more notes of the plurality of notes having a project tag and marked-up values, the plurality of notes are time and date stamped;
receiving, by the electronic device, through the interface, a delimiter before the second note;
identify, by the electronic device, the delimiter;
upon identification of the delimiter, selectively moving at a predetermined time, by the electronic device, based on the delimiter, the second note to the sub-list,
associating, by the electronic device, the second note with a predetermined function;
receiving, by the electronic device, a third note associated to the header, the third note arranged consecutively after the first note;
presenting, by the electronic device, the first note and the third note; and
providing, a report interface, on the electronic device, the report interface configured to receive a query for generating a report and presenting the report.

2. The method according to claim 1, wherein the method further comprises the steps of:
querying, by the electronic device, the plurality of notes in the sub-list based on the project tag, to identify the one or more notes having the project tag;
parsing, by the electronic device, the one or more notes having the project tag to retrieve the marked-up values associated with the one or more notes;
preparing, the report from the one or more notes, the project tag, and the marked-up values.

3. The method according to claim 2, wherein the report interface further comprises a predefined list of project tags and the project tag is selected from the predefined list of project tags.

4. The method according to claim 3, wherein the method further comprises the steps of:
storing, by the electronic device, the marked-up values into a plurality of variables based on pre-defined rules.

5. The method according to claim 4, wherein the report interface is configured to provide the predefined list of project tags, the plurality of variables, and formatting values, wherein the report interface is further configured to permit a user to select the project tag from the predefined list of project tags and one or more variables from the plurality of variables.

6. The method according to claim 5, wherein the method further comprises the step of retrieving dates of the one or more notes having the project tag and storing the dates in a date variable.

7. The method according to claim 6, wherein the report comprises the one or more notes having the project tag, the project tag, and the values associated with the one or more notes which are stored in the date variable and the one or more variables.

8. The method according to claim 1, wherein the method further comprises the steps of:
retrieving, by the electronic device, a predefined list of project tags;
querying, by the electronic device, the plurality of notes in the sub-list for each project tag in the predefined list of project tags to identify the notes having the project tags listed in the predefined list of project tags; and
parsing, by the electronic device, the notes having the project tags to retrieve the marked-up values, wherein the marked-up values are stored in a plurality of variables based on pre-defined rules,
wherein the report including the notes having the project tags, the project tags associated with the notes having the project tags, and the marked-up values associated with the notes having the project tags.

9. A non-transitory computer readable storage medium comprising instructions that, when executed by at least one processing device, cause the at least one processing device to:
provide an interface configured for receiving notes and delimiters from a user;
receive, through the interface, a first note and a second note, the first note and the second note are consecutive, the second note after the first note;
associate the first note and the second note to a header;
create a sub-list associated with the header, the sub-list having a plurality of notes, one or more notes of the plurality of notes having a project tag and marked-up values, the plurality of notes in the sub-list are date and time stamped;
receive, through the interface, two consecutive delimiters before the second note;
identify the two consecutive delimiters; and
upon identification of the two consecutive delimiters, selectively move at a predetermined time, the second note based on the two consecutive delimiters, to the sub-list;
receive, through the interface, a third note associated with the header, the third note consecutively arranged after the first note;
present the first note and the third note; and
provide, a report interface, on an electronic device, the report interface configured to receive a query for generating a report and presenting the report.

10. The non-transitory computer readable storage medium according to claim 9, wherein the processor further:
query the plurality of notes in the sub-list based on the project tag, to identify the one or more notes having the project tag;
parse the one or more notes having the project tag to retrieve the marked-up values associated with the one or more notes;
prepare the report from the one or more notes, the project tag, and the marked-up values.

11. The non-transitory computer readable storage medium according to claim 10, wherein the report interface includes a predefined list of project tags and the project tag is selected from the predefined list of project tags.

12. The non-transitory computer readable storage medium according to claim 11, wherein the processor further:
store the marked-up values into a plurality of variable based on pre-defined rules.

13. The non-transitory computer readable storage medium according to claim 12, wherein the report interface is configured to provide the predefined list of project tags, the plurality of variables, and formatting values, wherein the report interface is further configured to permit a user to select the project tag from the predefined list of project tags and one or more variables from the plurality of variables.

14. The non-transitory computer readable storage medium according to claim 13, wherein the processor further retrieve dates of the one or more notes having the project tag and storing the dates in a date variable.

15. The non-transitory computer readable storage medium according to claim 14, wherein the report comprises the one or more notes having the project tag, the project tag, and the values associated with the one or more notes which are stored in the date variable and the one or more variables.

16. The non-transitory computer readable storage medium according to claim 9, wherein the processor further:
retrieve a predefined list of project tags;
query the plurality of notes in the sub-list for each project tag in the predefined list of project tags to identify the notes having the project tags listed in the predefined list of project tags; and
parse the notes having the project tags to retrieve the marked-up values, wherein the marked-up values are stored in a plurality of variables based on pre-defined rules,
wherein the report including the notes having the project tags, the project tags associated with the notes, and the marked-up values associated with the notes.

17. A method for note taking and automated management of notes, the method comprising the steps of:
providing, an interface, on an electronic device, configured for receiving notes and delimiters from a user, the interface having a first header and a second header, wherein the second header is adjacent the first header, the electronic device comprising a memory unit and a processing unit connected to the memory unit;
receiving, by the electronic device, through the interface, a first note and a second note, the first note and the second note are consecutive, the second note after the first note, the first note and the second note are associated with the first header;
creating, by the electronic device, a sub-list associated with the first header, the sub-list having a plurality of notes, one or more notes of the plurality of notes having a project tag and marked-up values, the plurality of notes in the sub-list are date and time stamped;
receiving, by the electronic device, through the interface, one or two delimiters before the second note;
identify, by the electronic device, the one or two delimiters;
upon identification of the one or two delimiters, selectively moving at a predetermined time, by the electronic device, notes between the one or two delimiters and the second header to the sub-list;
providing, a report interface, on the electronic device, the report interface configured to receive a query for generating a report and presenting the report;
querying, by the electronic device, the plurality of notes in the sub-list based on the project tag, to identify the one or more notes having the project tag;
parsing, by the electronic device, the one or more notes having the project tag to retrieve the marked-up values associated with the one or more notes; and
preparing, the report from the one or more notes, the project tag, and the marked-up values.

18. The method according to claim 17, wherein the method further comprises the steps of:
storing, by the electronic device, the marked-up values into a plurality of variable based on pre-defined rules.

19. The method according to claim 18, wherein the report interface is configured to provide a predefined list of project tags, the plurality of variables, and formatting values, wherein the report interface is further configured to permit a user to select the project tag from the predefined list of project tags and one or more variables from the plurality of variables, wherein the report is prepared from the marked-up values stored in the one or more variables.
